(19) United States
(12) Patent Application Publication
(10) Pub. No.: US 2005/0246447 A1
(43) Pub. Date: Nov. 3, 2005

(54) Method, system and apparatus for monitoring and controlling data transfer in communication networks

(75) Inventors: Jeffrey Raymond Smidt, Burnett Heads Qld (AU); Arron Hollis, Burnett Heads Qld (AU)

Correspondence Address: HARNESS, DICKEY & PIERCE, P.L.C., P.O. BOX 828, BLOOMFIELD HILLS, MI, 48303, US

(73) Assignee: WEBTRAF RESEARCH PTY LTD, Bundaberg, Queensland (AU)

(21) Appl. No.: 10/519,263

(22) PCT Filed: Jul. 3, 2003
(86) PCT No.: PCT/AU03/00860

§ 371 Date: Dec. 22, 2004

(30) Foreign Application Priority Data
Jul. 4, 2002 (AU) PS 3391

(51) Int. Cl. G06F 15/16

(52) U.S. Cl. 709/229

(57) ABSTRACT

A method of monitoring and controlling data transfer between user terminals (4) coupled to a first communication network (7) and a second communication network (10) via a gateway (6) and a firewall (8) includes the user terminals (4) sending access requests to the gateway (6), the gateway (6) reading each access request, modifying access rules in the firewall (8) to permit access for each user terminal requesting access based on an authenticated IP address of each user terminal and monitoring simultaneously at the firewall (8) the transfer of data between each user terminal (4) and the second communication network (10). Bandwidth allocation to the terminals may be dynamically controlled on a global or local basis.

The invention relates to a method, system and apparatus for monitoring and controlling data transfer in communication networks. In particular, the invention relates to a method, system and gateway that enable an organization to monitor and control the data usage and online time of multiple terminals in an internal network. However, it is envisaged that the method, system and apparatus have other applications.

### BACKGROUND TO THE INVENTION

There are now very few businesses, organizations, undertakings or the like that do not rely on one or more computer systems of one description or another. The computer system may be, at one end of the spectrum, a single desktop personal computer/workstation/terminal used by a small business with a single employee or, at the other end of the spectrum, the computer system may comprise tens, hundreds or thousands of terminals connected to the same system via a plurality of servers on different networks connected to one or more mainframe computers.

Irrespective of the size of the computer system access is often required to a communication network other than the one to which the terminal is connected. To access, for example, an external communication network such as the Internet, an Internet service or access provider (ISP/IAP) is required. Commonly, the ISP/IAP provides the necessary software, username(s), password(s) and the like for a monthly fee. The fee may be a flat fee, such as with a broadband connection, or may be dependent on the amount of online time and/or data transferred, e.g. uploaded and/or downloaded.

It is desirable that individual users and/or organizations are able to monitor the amount of time spent connected to another communication network and the volume of data transmitted over that connection, e.g. for reconciliation and/or security purposes.

Returning to the Internet access example, a known method for monitoring online time is employed by, for example, Internet cafés, which enables the café to bill customers according to their period of usage at preset rates, depending on, for example, the nature of their usage, e.g. gaming, browsing, LAN. One such product is known as Geto Manager developed by Advanced Corn Tech Co. Ltd and details of this product are disclosed at www.swplaza.co.kr. This system comprises a plurality of user terminals networked to a management terminal (server), which may be used by members and non-members. Once users log in with an ID, a time counter commences automatically along with a fee calculator. If the user changes to another terminal, the change is automatically processed. Payment is made at the counter with a card or membership ID. In this system, the start time, account details such as pre- and post-payment details, remaining time and billing rate may be monitored by and displayed on the management terminal at, for example, the counter of the Internet café. Some of these details may also be displayed on the user's terminal. Control functions available to the management terminal include automatic locking/unlocking, rebooting and/or power switch off of individual terminals. However, this product cannot monitor the data volume being uploaded or downloaded by each terminal.

Monitoring the amount of data may be carried out on individual workstations using a conventional DU meter, which shows the amount of data being uploaded and/or downloaded and the data upload/download rate. Details of a DU meter by Hagel Technologies are described at http://www.dumeter.com. The DU meter allows the monitoring period to be configured by the user, provides alerts when data uploads and or downloads exceed a user-specified volume in a user-specified period and provides alerts when online time exceeds a user-specified time limit. However, this facility only functions relatively accurately on an individual machine. For example, in an internal network of multiple user terminals connected to the Internet, a DU meter would register all traffic coming to the terminal on which the DU meter is installed, including traffic through the Internet gateway and crosstalk between the multiple user terminals. The DU meter is incapable of discerning the function of the data packets or their origin.

Hence, there remains a need for a system and/or method and/or apparatus that enables monitoring of data usage and time usage of any one or multiple users over multiple terminals coupled to one or more communication networks. It is also desirable that the system and/or method and/or apparatus enables analysis of data and time usage of the users/terminals and includes security measures to permit/deny access to one or more external communication networks.

### DISCLOSURE OF THE INVENTION

According to one aspect, although it need not be the only or indeed the broadest aspect, the invention resides in a method of monitoring and controlling data transfer between a user terminal coupled to a first communication network and a second communication network via a gateway and a firewall, said method including the steps of:
sending an access request to said gateway from a said user terminal requiring access to said second communication network;
said gateway reading said access request;
modifying at least one access rule in said firewall to permit access for said user terminal requesting access based on an authenticated IP address of said user terminal;
monitoring simultaneously at said firewall transfer of data between said user terminal and said second communication network; and dynamically controlling in real time bandwidth available to said user terminal.

The dynamic control of bandwidth available to the user terminal may occur whilst maintaining communication of the user terminal with the second communication network.

A restricted bandwidth may be allocated on the fly to a single user terminal, a plurality of user terminals and/or one or more specified user accounts. Bandwidth may be controlled for uploading and/or downloading data.

The method may further include the step of monitoring all ports of access of the user terminal.

The method may further include the step of enabling and/or disabling one or more ports of access to each user terminal.

Optionally, a single machine may include the gateway and the firewall. Alternatively, the firewall may be in a different machine from the gateway.

Authentication of the IP address is preferably carried out by the gateway. Authentication may be carried out using an encryption/decryption process.

The method may further include the step of controlling access of a user terminal to the second communication network from a management terminal coupled to the first communication network.

The method may further include the step of monitoring a period of time a user terminal has access to the second communication network.

The method may further include the step of monitoring a quantity of data a user terminal uploads and/or downloads.

The method may further include the step of monitoring a cost to a user of their user terminal having access to the second communication network.

According to another aspect, the invention resides in a system for monitoring and controlling data transfer in communication networks, said system comprising:
one or more user terminals coupled to a first communication network;
a second communication network coupled to said first communication network via a gateway and a firewall;
wherein said firewall simultaneously monitors transfer of data between said one or more user terminals and said second communication network for said user terminals having an authenticated IP address that has access to said second communication network and dynamically controls bandwidth in real time available to said one or more user terminals.

Optionally, a single machine may include the gateway and the firewall. Alternatively, the firewall may be in a different machine from the gateway.

Authentication of the IP address is preferably carried out by the gateway and may involve an encryption/decryption process to authenticate a remote terminal.

A restricted bandwidth may be allocated on the fly to a single user terminal, a plurality of user terminals and/or one or more specified user accounts. Bandwidth may be controlled for uploading and/or downloading data.

According to a further aspect, the invention resides in a gateway for monitoring and controlling data transfer in communication networks, said gateway comprising:
a firewall for permitting access to a second communication network for one or more user terminals coupled to a first communication network having an authenticated IP address;
wherein said gateway monitors simultaneously at said firewall transfer of data between said one or more user terminals and said second communication network and dynamically controls bandwidth in real time available to said one or more user terminals.

The gateway may further comprise means for enabling and/or disabling one or more ports of access to each user terminal.

Further aspects and features of the invention will become apparent from the following description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows a schematic representation of a computer system in accordance with the present invention in which the method and apparatus of the present invention may be implemented;

FIG. 2 shows a flowchart depicting the method steps of the present invention for connecting and disconnecting a user terminal to an external communication network such as the Internet;

FIG. 3 shows a screenshot of part of a monitoring and control interface for monitoring terminal activity;

FIG. 4 shows a screenshot of part of the monitoring and control interface for setting pricing structures;

FIG. 5 shows a screenshot of part of a monitoring and control interface showing terminals defined within a network; and

FIG. 6 shows a screenshot of part of a monitoring and control interface for editing settings for a particular user terminal or user account.

### DETAILED DESCRIPTION OF THE INVENTION

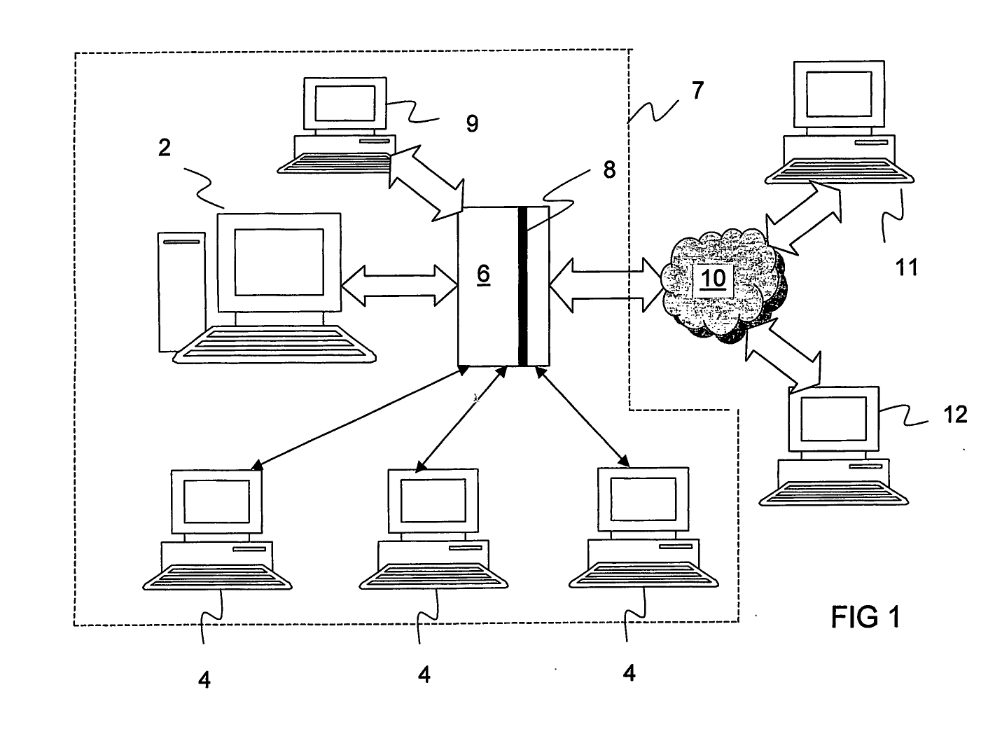

The method of the present invention may be implemented in the system of the present invention shown in FIG. 1. FIG. 1 may represent a computer system in, for example, an Internet café, a small, medium-sized or large business or other form of organization utilizing a computer system. However, the system of the present invention is not limited to the example shown in FIG. 1 and the system of the present invention may apply to any two communication networks coupled by a gateway.

The system in FIG. 1 comprises one or more user terminals 4 and one or more management terminals 2 coupled to gateway terminal 6. The management terminal(s) 2 can also be considered as user terminals. Together, user terminal(s) 4, management terminal(s) 2 and gateway 6 may be considered as a first communication network in the form of an internal network 7. The gateway 6 may also comprise a firewall 8 employing any known firewall technique that allows customizable rules. Alternatively, the firewall 8 may be installed in a separate machine such as terminal 9 coupled to the gateway 6. The internal network 7 communicates through gateway 6 with one or more second communication networks in the form of one or more external networks 10. Such external networks 10 are external to the internal network 7 and may be the Internet, wide area networks, or secured sections of any network based on the Internet Protocol TCP/IP. Persons skilled in the art will appreciate that the gateway 6 may also be associated with a router located between the gateway and the external network 10 and a switch located between the gateway 6 and the terminals 2, 4 to direct information in and out of the gateway 6.

As alternatives to the system shown in FIG. 1, the system of the present invention may comprise a gateway 6 and firewall 8 between two public networks or between two private networks and therefore the system and method of the present invention are not limited to the internal and external networks shown in FIG. 1. It will therefore be appreciated that the internal and external networks referred to in the following example may be substituted for public or private networks or a combination thereof.

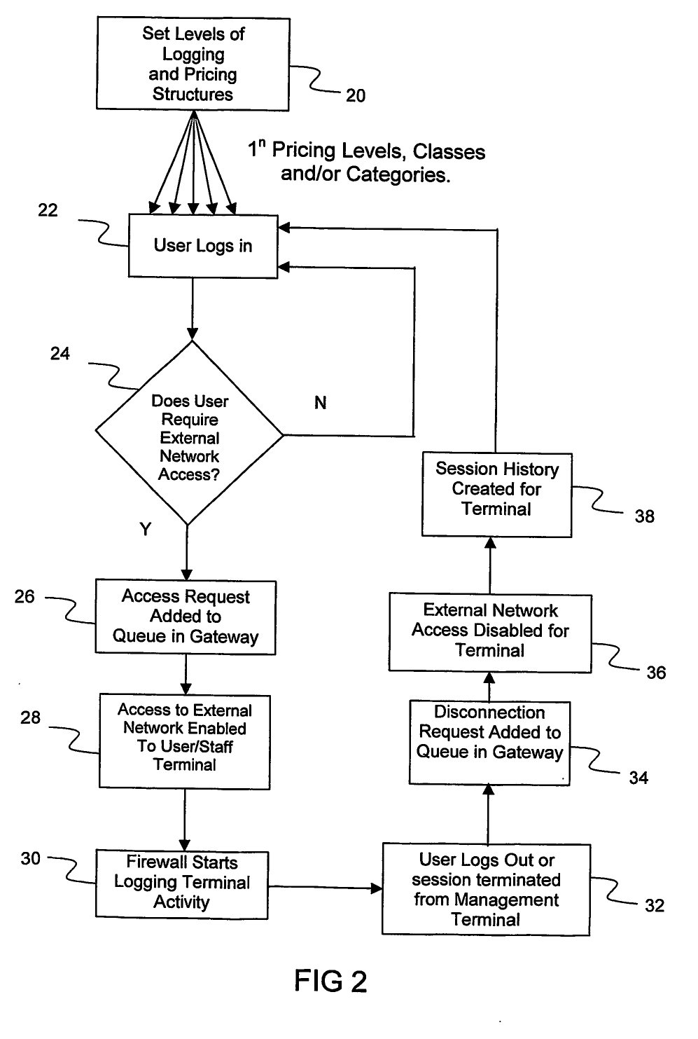

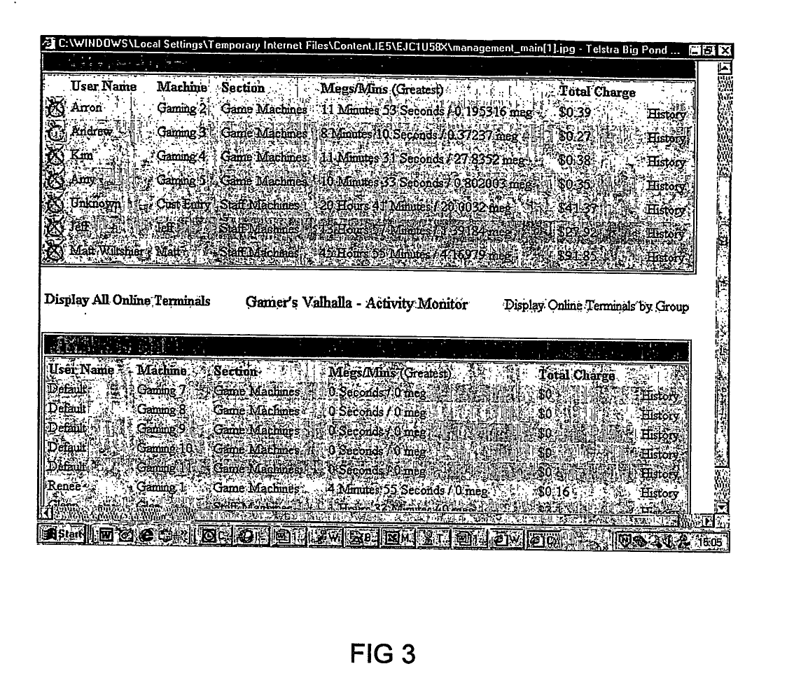

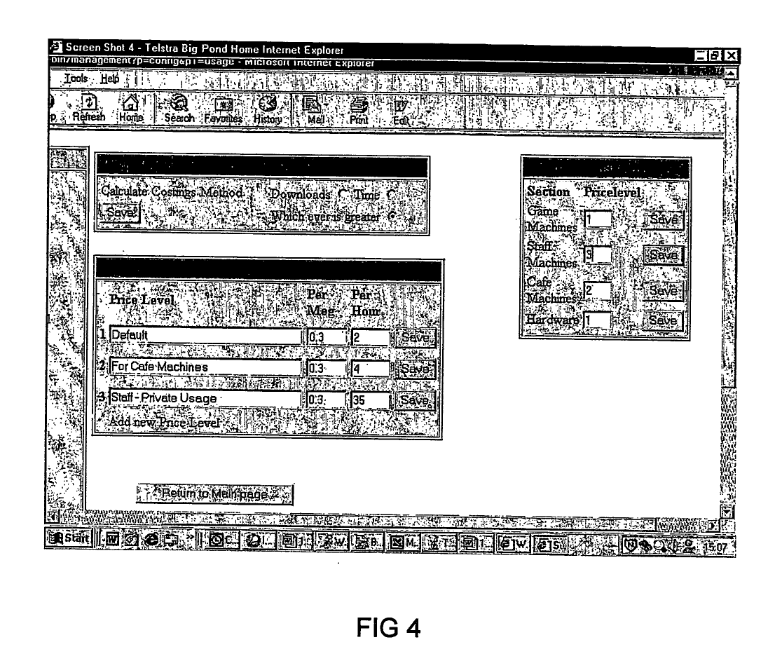

The method of the present invention is described with further reference to the flowchart in FIG. 2 and the screenshots in FIGS. 3-6. At step 20, the levels of logging, such as gaming or browsing or other functions, are set, as well as levels of pricing, if appropriate. Examples are shown in FIG. 4. Logging of activities is carried out by the firewall 8 and may be carried out on a per data quantity basis, e.g. per Mb, and/or on a per unit time basis, e.g. per second, per minute or other time period. For example, time may be logged at a preset cost per unit time. There may also, or alternatively, be a data upload and/or download limit, which, if exceeded, may incur a further charge in addition to, or as an alternative to, the time spent by the user at the terminal. Alternatively, the cost may be charged on whichever is greater based on time or uploads/downloads. It will be appreciated that there are many permutations by which logging may be carried out and that the present invention is not limited to any particular permutation.

At step 22, a user logs into a user terminal 4, such as a customer in an Internet café or an employee in a business. There may be any number of pricing levels, classes or timing categories or the like, which will depend on the particular user and/or the application, e.g. large organization, Internet café.

With reference to step 24 in FIG. 2, if a user does not require access to an external network 10, such as the Internet, the monitoring and control method of the present invention does not come into operation and once the user has logged in they are enabled for their own network, i.e. not an external network. However, if a user does require, for example, Internet access, a request for access in the form of a data packet containing the Internet protocol (IP) address of the user's terminal may be added to an access queue in the gateway 6, as represented by step 26. However, operating speeds are sufficiently high that queuing will usually be unnecessary and the requests will be processed substantially instantaneously.

When the IP address is read by the gateway 6, the gateway generates a rule to instruct the firewall 8 to permit access to that IP address. The firewall 8 follows the generated rule and permits external network access to that IP address, as represented by step 28, providing the IP address has been authenticated via a username and password at the gateway 6 for access to an external network 10. Access to an external network is granted to the user and the terminal by amending one or more rules in a list of rules followed by the firewall. The rules enable the firewall to permit or deny network access to specific IP addresses. Rules may be added or removed. Alternatively, existing rules may be changed/updated to permit or deny external network access.

FIG. 3 shows a monitoring and control interface available on the management terminal 2, which shows those terminals that are and are not in use. The identity of each terminal and the section to which it belongs within its network are displayed in addition to the user of that terminal. The usage time, the data volume downloaded in Mbs and the associated cost are displayed.

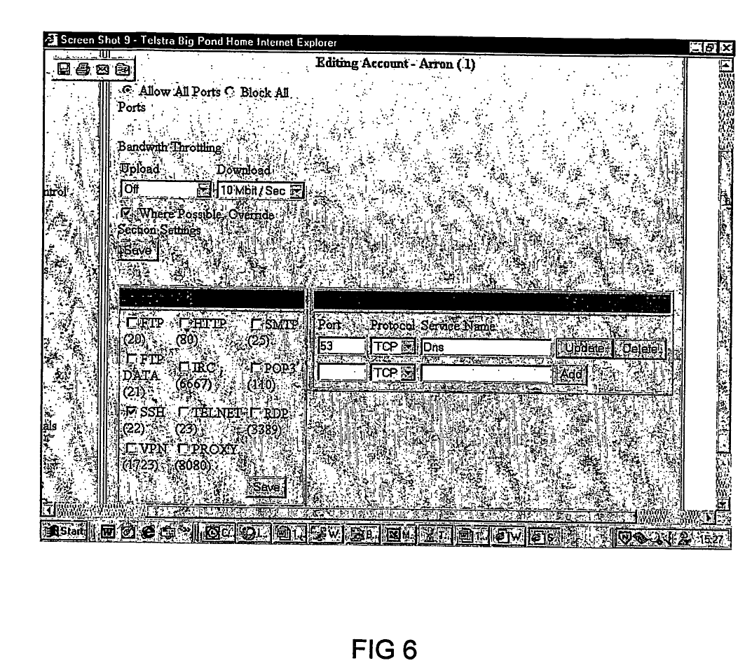

When external network access is enabled for a particular terminal, specific access port numbers of that terminal may be enabled/disabled to permit/forbid respectively particular activities, such as gaming and/or browsing and/or other activities being performed from the terminal. The particular ports of access to a terminal that are enabled/disabled may depend on the particular user and/or on the particular terminal. Enabling/disabling of the ports is controlled by the rules provided to and followed by the firewall 8. The rules may be set up, for example, when a user account is created. A default option may be that all ports are activated to permit all activities at a terminal, as shown in the top left hand corner of FIG. 6.

FIG. 6 also shows that exceptions may be specified to the settings of “Allow All Ports” or “Block All Ports”. For example, FIG. 6 shows that all ports are allowed for the Arron(1) account for all activities except SSH (Secure Shell) because the SSH box is checked in the Exceptions section. SSH allows the user to log into another terminal over the external communications network or another network to execute commands in the remote terminal and to move files from one machine to another. One or more of the exceptions boxes may be checked to permit or forbid the activity represented by the box, depending on whether the “Block” or “Allow” box for the ports is checked respectively. Another example might be that HTML is permitted, but no other type of data transfer.

With further reference to FIG. 6, the bandwidth, or data transfer rate, allocated to one or more terminals may also be dynamically controlled on the fly by the system and method of the present invention. Bandwidth may be controlled globally or locally and in real time without interfering with the network to which the terminal is coupled or otherwise interrupting communications.

Global bandwidth settings affect every terminal connected to the gateway 6 and any changes to the settings are effected globally. For example, if port 80, which is generally used for Internet connection, is blocked globally, each terminal connected to the gateway 6 will not be able to access the Internet via port 80. In another example, if a bandwidth of, for example, 2 Mb/s is allocated for web access, all terminals connected to the Internet will share the 2 Mb/s bandwidth.

Local bandwidth settings only affect one or more specified terminals or user accounts. For example, a specified bandwidth may be allocated to a particular terminal, such as the management terminal 2. The advantage of allocating a specified bandwidth to a user account on the other hand, as shown in FIG. 6, is that the user will be able to use their allocated specified bandwidth irrespective of the terminal that they are logged into. In the example shown in FIG. 6, no bandwidth restriction is set for uploads, but the download bandwidth is limited to 10 Mb/s for the Arron(1) user account.

A further feature of the bandwidth control is that exceptions may be specified to the bandwidth restrictions as shown in FIG. 6. For example, in FIG. 6, as with the port limitation example described above, the SSH (Secure Shell) box is checked. In this example, the 10 Mbits download limit therefore will not apply to SSH download operations for this user account. The other, non-exhaustive examples of bandwidth restriction exemptions shown in FIG. 6 are for protocols/applications/networks that will be familiar to persons skilled in the art.

The dynamic bandwidth allocation feature of the present invention allows bandwidth to be allocated to users, terminals and/or groups thereof as required. For example, organizations such as schools and other educational institutions usually only have a limited bandwidth allocation and the present invention allows the bandwidth or a part thereof to be allocated to one or more terminals for, e.g. a media streaming event. The bandwidth allocation may be for a prescribed time period after which, the bandwidth may be reallocated, e.g. to one or more different terminals.

Bandwidth allocation may be on a priority basis whereby users and/or specific terminals are allocated a priority, e.g. a number 1 to 5. If two or more terminals and/or users are competing for bandwidth, the terminal and/or user with the highest priority is allocated the bandwidth.

Another scenario could be a medical environment such as a hospital, where bandwidth requirements can vary rapidly. For example, data files containing medical images such as X-rays, MRI and/or CAT scans, which can be large, often need to be transferred between networks within and between medical establishments. Bandwidth may be allocated dynamically to facilitate the transfer of such files. This enables the file(s) to be transferred rapidly, which is often necessary in emergency situations and prevents the computer system of the medical establishment from grinding to a halt while the file(s) are transferred.

Once network access to a specific IP address is permitted, logging of that terminal's activity is commenced by the firewall 8, as represented by step 30 in FIG. 2. The type of data that will be logged includes start time, current session time, monetary cost incurred this session, user/customer limit(s) (in terms of time, expenditure and/or data volume), account type (e.g. debit or credit) and/or account status. Firewall 8 records such data for each particular IP address connected to the external network 10. This data can then be requested by the gateway 6 and displayed, as described hereinafter.

Once a user has logged in and gained access to the external network 10, it is not possible for the user to revert back to a previous screen prior to log in, e.g. by clicking on the “back” button, in an attempt to circumvent the monitoring and logging of their session by the method of the present invention.

Once a user has completed their session, e.g. at the end of a working day in the case of a business employee, the user logs out of the terminal, as shown at step 32. Alternatively, the gateway 6 and firewall 8 may cause the user to be logged out and disconnected from the external network 10 if, for example, the user's preset time limit has expired. This may be set such that a user's session is terminated automatically. Alternatively, an operator of the management terminal 2 may effect session termination by initiating a disconnection request. In this way the operator can inform the user prior to session termination to avoid a user losing any important data. A user may only terminate their own session and not the session of another user unless this is done via a management terminal 2. In this case it should be an authorized staff member e.g. in the case of an organization or Internet café, who will have the required username and password to use a management terminal 2.

Once logging out has been initiated, either by the user or by the request from a management terminal 2, a request for disconnection from the external network in the form of a data packet containing the IP address of the terminal to be disconnected may be added to a disconnection queue in the gateway 6, as represented by step 34. Once again however, queuing will usually be unnecessary and the request for disconnection will be processed substantially instantaneously.

When the IP address of the disconnection request is read, the rule(s) that permits access for that particular IP address is/are removed/amended from/in the firewall 8 and the firewall disables access to the external network for that IP address, as represented by step 36 in FIG. 2.

Once the firewall 8 has processed a queued connection request or disconnection request, that request is cleared from the queue to prevent processing of the request being duplicated in error.

A session history is maintained by the gateway 6 based on the data logs created by the firewall 8, as represented by step 38. Each session history contains relevant information for that particular user terminal and/or that particular user. The relevant information may include the terminal and user ID, log on and log off times, session duration, billing rate, data volume consumption/upload/download, data upload/download limit(s), session cost, payment method, account status, URLs visited and the time spent visiting each URL and other such information. The type of information contained in the session history may be determined by the gateway 6 and the firewall 8 on a per user and/or per terminal basis as required. This information may be compared to billing information that is supplied by the service provider.

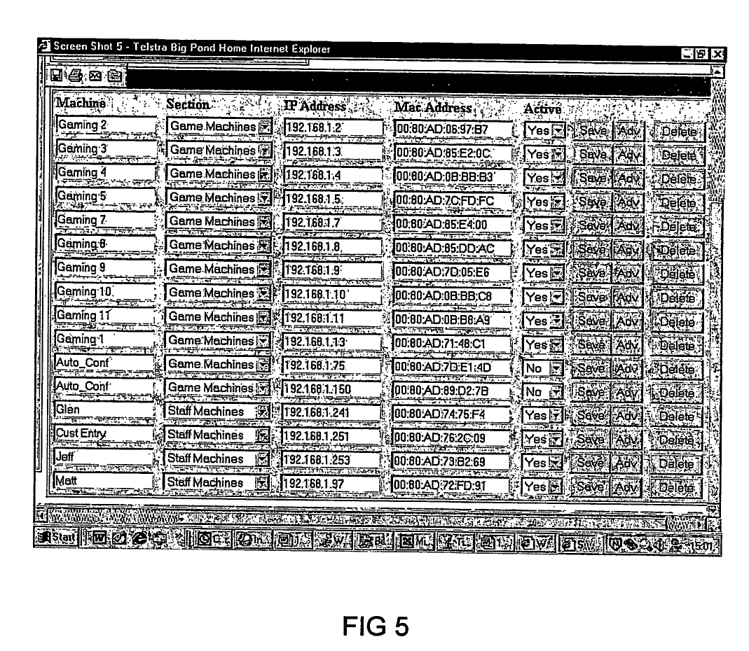

The activity of users can be monitored at a management terminal 2 by virtue of the monitoring and control interface in the form of, for example, a table displaying which terminals are and which terminals are not in use and the relevant data associated with that terminal usage, as shown in FIGS. 3-6 and described herein. However, the present invention is not limited to the monitoring and control interface being accessible just on a single management terminal. The interface may be accessed on any terminal in the system that has been given access to management controls. FIG. 5 shows a table displaying details of the currently defined terminals (machines), which includes the identity of the machine, the section to which it belongs, its IP address, a Media Access Control (MAC) address and whether or not the terminal is active.

If, for example, there is a problem with the gateway 6 or there is power loss and external network access is lost to all terminals, the present invention enables a management terminal 2 to reconnect each terminal with the external network with which it was connected before connection was lost (providing connection to the relevant external network is possible). The firewall 8 accepts a request to restore the external network connection from a management terminal 2. The firewall restores the connections to their previous status since the IP addresses of the terminals have previously been verified by the gateway 6 and enabled by the firewall 8. Each individual user does not need to request access to the external network 10 again for that session.

The monitoring and control interface, which is accessible on whichever terminal(s) is/are operating as a management terminal, offers the operator other control features including, but not limited to, a general settings feature, back up options, accounts, access settings and display/edit of staff access codes.

The general settings feature provides control over the firewall 8 and/or the gateway 6 and enables the monitoring and control method to operate as a passive booking system. This enables time slots to be allocated to particular users and/or particular terminals. Hence, if a particular time slot or terminal has been reserved and a different user attempts to log on to the reserved terminal during the reserved time slot, an alert will be activated to the user and/or the management terminal 2. The operator of the management terminal may be given the option to override the time slot and/or terminal reservation.

Varying levels of security access may be set for different staff and managers and the like according to their permissions/seniority/security clearance or the like. For example, staff may have their own log in screens to enable monitoring and, to an extent, control of their own terminal usage by the method of the present invention. Staff may be permitted to enable/disable external network access, but may not be able to, for example, view accounting details, which could be reserved for managerial access.

The back up options feature may, for example, provide for one or more alternative server addresses, identifications and/or passwords in the event of failure of those normally employed.

The present invention may be used for a “walled garden” in, for example, a motel or educational establishment. Accessing sites within the controlled browsing environment may be free, but accessing sites outside the walled garden may incur a fee. The firewall 8 will monitor all access and log charges accordingly.

The method of the present invention enables the data related to staff/user access described above to be monitored and access to one or more networks external to the terminal being monitored to be controlled remotely on a per user, per machine basis and/or on a per user over multiple machines basis. This includes not only time monitoring, but also data volume usage monitoring because the traffic for each IP address, i.e. terminal, is being logged by the firewall 8 and monitored at the gateway 6.

The system employing the method is also resistant to security breaches of the system because the method monitors all traffic through the gateway 6 and firewall 8. Any attempted unauthorized access from an external terminal 11 will require the IP address associated with the external terminal 11 to be identified. The firewall 8 creates logs for each terminal based on the IP address of the terminal and the user ID entered by the user of that terminal. The rules of the firewall will not have been altered/added to in order to permit access/traffic flow between the external terminal 11 and the internal network 7 via the firewall 8 and the gateway 6. Therefore, the external terminal should not gain access to the internal network 7. Furthermore, the method of the present invention restarts the firewall periodically after a short time period, e.g. 2 seconds, has elapsed. Therefore, in the event that the unauthorized external terminal 11 somehow disables the firewall 8, it will be restarted within a short time to once again automatically deny access to the unauthorized external terminal 11. The restarted firewall 8 will not include an authenticated IP address of the external terminal 11. Any activity of the unauthorized external terminal will therefore be identified because their activities will be logged and the unauthorized external terminal 11 will be identified by an alert on the management terminal(s). Similarly, any unauthorized terminals may not be connected to the network since they will have an unrecognized IP address. Therefore, a member of staff e.g. in a business, or a member of the public using an Internet café, cannot connect their own machine to the network.

The method, system and apparatus of the present invention also allows for permitting access to the internal network 7 by one or more authorized remote terminals 12 that are not part of the internal network 7 shown in FIG. 1. Authorization may be conducted via, for example, email and/or using security keys. For example, the gateway 6 may comprise a public encryption key supplied by a user of a remote terminal 12. The user of the remote terminal 12 will have a private encryption/decryption key. When the remote terminal requests access to the internal network 7, the gateway 6 will send a message encrypted with the public key to the remote terminal. The remote terminal 12 decrypts the encrypted message and returns the decrypted message to the gateway 6. The gateway compares the received decrypted message with the original unencrypted message. If they are the same the identity of the remote terminal has been successfully authenticated and the gateway 6 grants access to the internal network 7 to the remote terminal 12. The gateway then acquires the IP address of the remote terminal 12 from the access data packets and the gateway can monitor the activity of the remote terminal 12 as described for terminals 4 herein. If the original and decrypted messages differ, access is denied since the identity of the remote terminal has not been verified. A user ID and password may be used in conjunction with the security keys. This method of permitting access to remote terminals applies to both permanent and temporary external IP addresses. The activities of the remote terminals will also be displayed on the management terminal(s).

The method of the present invention operates on any known operating system that has HTML capability on the staff/user terminals, although the Unix/Linux operating system is preferred. Where the server side needs more than HTML capabilities, it has to be configured to the appropriate operating system's gateway/firewall structures.

The present invention works with wireless networks, network printers and/or any program or device that works over TCP/IP protocol. The method also fully supports Dynamic Host Controller Protocol (DHCP) and may be employed on larger networks requiring subnets and a plurality of gateways. The method and gateway may be installed via a conventional bootable flash memory familiar to persons skilled in the art. The present invention does not require specialist software to be installed on each terminal that is to be monitored and reconfiguration of the network is not required. Software only needs to be installed on the gateway machine and the gateway will search for machines connected to the network.

Another advantage of the present invention is that it does not cache any data, e.g. data relating to web pages, which is performed by some of the prior art systems. Hence, the present invention enables users to, for example, view current web pages and not potentially out of date web pages that have been cached.

Throughout the specification the aim has been to describe the invention without limiting the invention to any one embodiment or specific collection of features. Persons skilled in the relevant art may realize variations from the specific embodiments that will nonetheless fall within the scope of the invention.

1. A method of monitoring and controlling data transfer between a user terminal coupled to a first communication network and a second communication network via a gateway and a firewall, said method including the steps of:
sending an access request to said gateway from said user terminal requiring access to said second communication network;
said gateway reading said access request;
modifying at least one access rule in said firewall to permit access for said user terminal requesting access based on an authenticated IP address of said user terminal requesting access;
monitoring simultaneously at said firewall the transfer of data between said user terminal and said second communication network; and
dynamically controlling in real time bandwidth available to said user terminal.

2. The method of claim 1, wherein said dynamic control of bandwidth available to said user terminal occurs whilst maintaining communication of said user terminal with said second communication network.

3. The method of claim 1, wherein a restricted bandwidth is allocated to a single user terminal.

4. The method of claim 1, wherein a restricted bandwidth is shared between a plurality of user terminals.

5. The method of claim 1, wherein bandwidth is restricted for uploading data and/or downloading data.

6. The method of claim 1, wherein a restricted bandwidth is allocated to one or more terminals for a prescribed time period.

7. The method of claim 1, wherein a restricted bandwidth is allocated to one or more terminals on the basis of a priority status allocated to the one or more terminals or a user account.

8. The method of claim 1, wherein the IP address of a user terminal is authenticated on the basis that the user terminal has previously been authenticated by the gateway using an encryption/decryption process.

9. The method of claim 1, further including the step of monitoring all ports of access of said user terminal.

10. The method of claim 1, further including the step of enabling and/or disabling one or more ports of access of a user terminal.

11. The method of claim 1, further including the step of controlling access of a user terminal to the second communication network from a management terminal coupled to the first communication network.

12. The method of claim 1, further including the step of monitoring a period of time a user terminal has access to the second communication network.

13. The method of claim 1, further including the step of monitoring a quantity of data a user terminal uploads and/or downloads.

14. The method of claim 1, further including the step of monitoring a cost to a user of their user terminal having access to the second communication network.

15. A system for monitoring and controlling data transfer in communication networks, said system comprising:
one or more user terminals coupled to a first communication network;
a second communication network coupled to said first communication network via a gateway and a firewall;
wherein said firewall simultaneously monitors transfer of data between said one or more user terminals and said second communication network for said user terminals having an authenticated IP address that has access to said second communication network and dynamically controls in real time bandwidth available to said one or more user terminals.

16. The system of claim 15, wherein a single machine comprises both the gateway and the firewall.

17. The system of claim 15, wherein the firewall is in a different machine from the gateway.

18. The system of claim 15, wherein authentication of the IP address is carried out by the gateway.

19. The system of claim 18, wherein authentication employs an encryption/decryption process to authenticate a remote terminal.

20. The system of claim 15, wherein the firewall simultaneously monitors all ports of access of one or more of said user terminals.

21. The system of claim 15, wherein a restricted bandwidth is allocated to a single user terminal.

22. The system of claim 15, wherein a restricted bandwidth is shared between a plurality of user terminals.

23. The system of claim 15, wherein a restricted bandwidth is allocated to a user account.

24. The system of claim 15, wherein bandwidth is restricted for uploading data and/or downloading data.

25. The system of claim 15, wherein said dynamic control of bandwidth available to said one or more user terminals occurs whilst maintaining communication of said one or more user terminals with said second communication network.

26. A gateway for monitoring and controlling data transfer in communication networks, said gateway comprising:
a firewall for permitting access to a second communication network for one or more user terminals coupled to a first communication network having an authenticated IP address;
wherein said gateway monitors simultaneously at said firewall transfer of data between said one or more user terminals and said second communication network and dynamically controls in real time bandwidth available to said one or more user terminals.

27. The gateway of claim 26, wherein the firewall simultaneously monitors all ports of access of one or more of said user terminals.

28. The gateway of claim 26, wherein the dynamic control of bandwidth available to said one or more user terminals occurs whilst maintaining communication of said one or more user terminals with said second communication network.

29. The gateway of claim 26, further comprising means for enabling and/or disabling one or more ports of access to each user terminal.
